(19) United States
(12) Patent Application Publication
(10) Pub. No.: US 2010/0153994 A1
(43) Pub. Date: Jun. 17, 2010

(54) DISTRIBUTION OF VIDEO ASSETS WITH MULTIPLE ADVERTISEMENTS

(76) Inventor: James H. Alexander, Highlands Ranch, CO (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/336,727

(22) Filed: Dec. 17, 2008

(51) Int. Cl. H04N 7/025

(52) U.S. Cl. 725/35; 725/32

(57) ABSTRACT

A cable system receives a single copy of a video program, a plurality of ads, and meta-data associated with the ads at a receiver. The program is to be broadcasted on the cable system more than once, with different ads associated with each broadcast, which are typically inserted at the beginning, middle, and end of the program. The video program, ads, and meta-data are stored in a database, which are typically retrieved when the first broadcast occurs. At a first broadcast of the video program, an ad-selector processor retrieves the program and selects the ads using the meta-data, which includes ad-specific meta-data associated with each respective ad. Flexibility is afforded in ad selection for the various broadcasts of the program. The selection can be fixed by the program originator, or flexibility can be accommodated allowing the cable service provider in selecting ads for a broadcast.

### FIELD OF INVENTION

This disclosure generally pertains to system and methods for distribution of video assets to a cable system provider wherein the video asset incorporates multiple advertisements.

### BACKGROUND OF THE INVENTION

There are various architectures used to accomplish the distribution of advertisements (“ads”) that are presented with television programs to television viewers. The mechanisms accommodate the various type of technologies, including landlines, satellite, and cable distributions networks. In addition, ads can be presented with live broadcast programs, local programs, and even video-on-demand programs.

Video Content Program Providers (“VC Provider”) provide their video programs (“programs”), in some instances, with ads embedded therein. This is often the case when the VC Provider provides a program with a national viewing audience to a large number of cable service providers. The ads could be appended at the beginning (pre-pended or “pre-roll” ads), appended at the end of the program (post-pended or “post roll” ads), or be placed within (“interstitial” ads). Because the same program may air on different cable channels at different times or otherwise repeated on the same cable channel, the program provider may distribute the same programs with different ads embedded within it. Thus, the program provider distributes many versions of the same program with different ads to the cable service provider.

In one scenario, shown in FIG. 1, a VC provider 100 distributes a television program along with its associated advertisement to a transmission/distributor 120, which in turn provides the television programs with the embedded advertisements therein to a cable service provider (which can be a multiple system operator or “MSO” 140). Once the MSO 140 receives the program, it plays it out on the cable distribution network 140, where the program 102 with the ad is viewed by the viewer using a set top box 150.

The VC Provider 100 typically prepares a series of programs 101 and ads, which are the same program but with different embedded ads 102. Thus, for one week (Week 1) the program 101a may have a particular ad 102b embedded therein which is selected from a set of ads 104a, 106a, and 108a. For Week 2, the program 101b may have a second ad 110b which is selected from the same set of ads, and for Week 3, the program 101c will have a separate ad 112b embedded therein. Each week, the VC Provider transmits 115 the appropriate ad and program to the transmission/distributor 120, which in turn forwards it to the MSO 140. Thus, the program and ad 110 conveyed during the second week contains the same program, but a different ad than the first week 102, and so forth. Typically, the distributor 120 charges the VC Provider each time a program is transmitted, so that repeating the same program with different ads results in multiple charges to the to VC provider.

This approach consumes excessive transmission resources and requires that multiple programs with embedded ads be prepared for distribution. Further, there is no flexibility afforded to downstream entities as to the selection of which ads are to be used with the broadcasting of a program. Therefore, more efficient and less costly systems and methods for transmitting programs with embedded ads therein are required.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 discloses a prior art method of distributing programs with embedded ads therein.

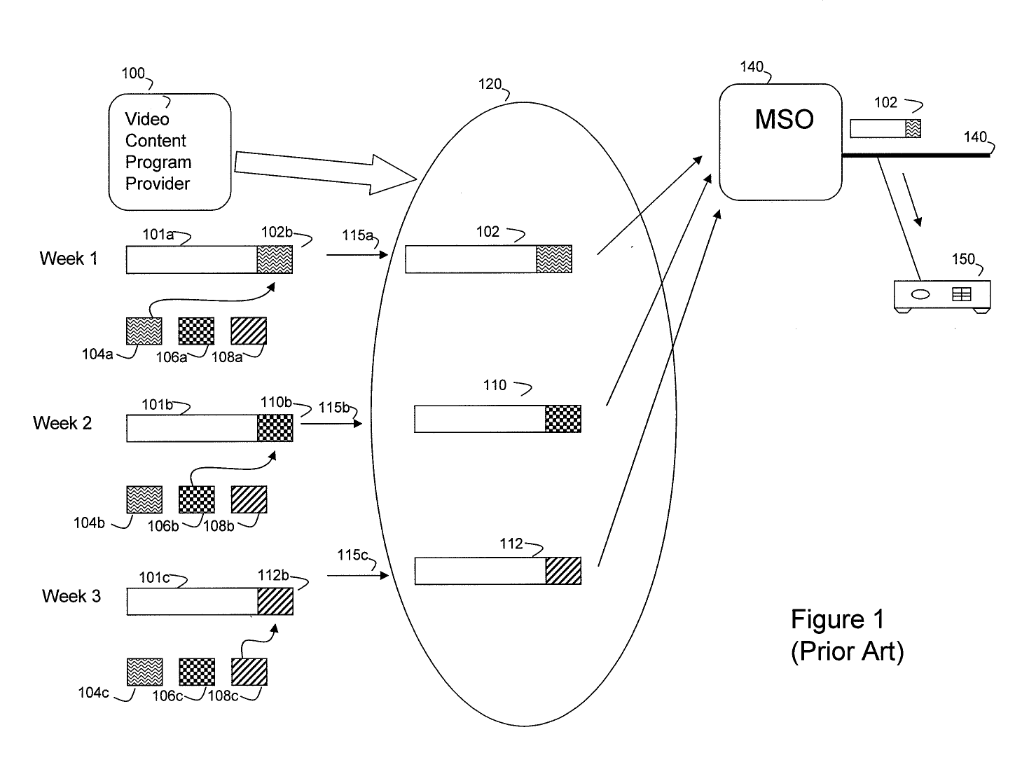

FIG. 2 discloses one embodiment of the present invention of distributing programs with embedded ads therein.

FIG. 3 discloses another embodiment of the present invention of distributing programs with embedded ads therein.

FIG. 4 discloses one embodiment of conveying meta-data with a plurality of ads.

FIG. 5 discloses one embodiment of the structure of the meta-data.

FIG. 6 discloses one embodiment of the system processing the meta-data to select one of the plurality of ads.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

The present invention avoids the requirement of transmitting the same program multiple times, where each transmission includes a different ad combined with the same program. Rather, a single transmission of the video content is accomplished where multiple ads, which can be viewed as a library of ad are included along with meta-data, which indicates instructions for selecting the appropriate ad from the ad library. Then, the MSO, upon receipt of the video content, processes the meta-data to determine which one of the ads is to be selected and embedded with the video program. Thus, the combining of the ad with the program as appropriate does not occur solely by the video content provider, but meta-data is included which can be used by the cable services provider to select the ad.

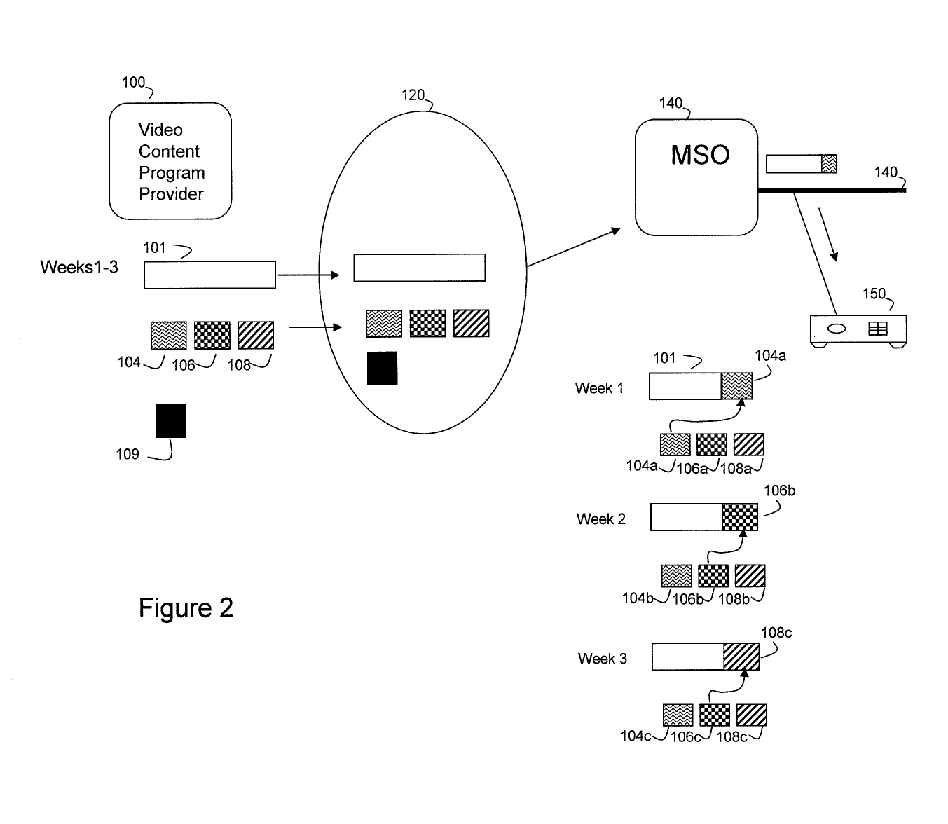

One embodiment of the present invention is shown in FIG. 2. In FIG. 2, the VC Provider 100 assembles a series of separate files, in this case at least three, covering a period of time. In this embodiment, each period being a week. In this embodiment, the VC program 101 is one file, and a series of ads are compiled in a series of separate files 104, 106, and 108, and a meta-data file 109. These are provided simultaneously (or at different times) to the distributor 120, which then arranges for the distribution of the files to the destination MSO 140. The distributor may use satellite, optical fiber networks, IP networks or any other technology for the distribution of the files to the MSO.

At the MSO, the files are received and assembled to provide the program with the embedded ad to the set top box 150. This is accomplished by processing the meta-data file 109 to obtain the various instructions and rules for selecting and embedding the appropriate ad 104, 106, or 108. Thus, in the first week, the program 101 is combined with ad 104a as defined by the meta-data file 109. In the second week, the program is combined with the next ad 106b as instructed by the meta-data file. In the third week, the last ad 108c is selected and embedded with the video content program.

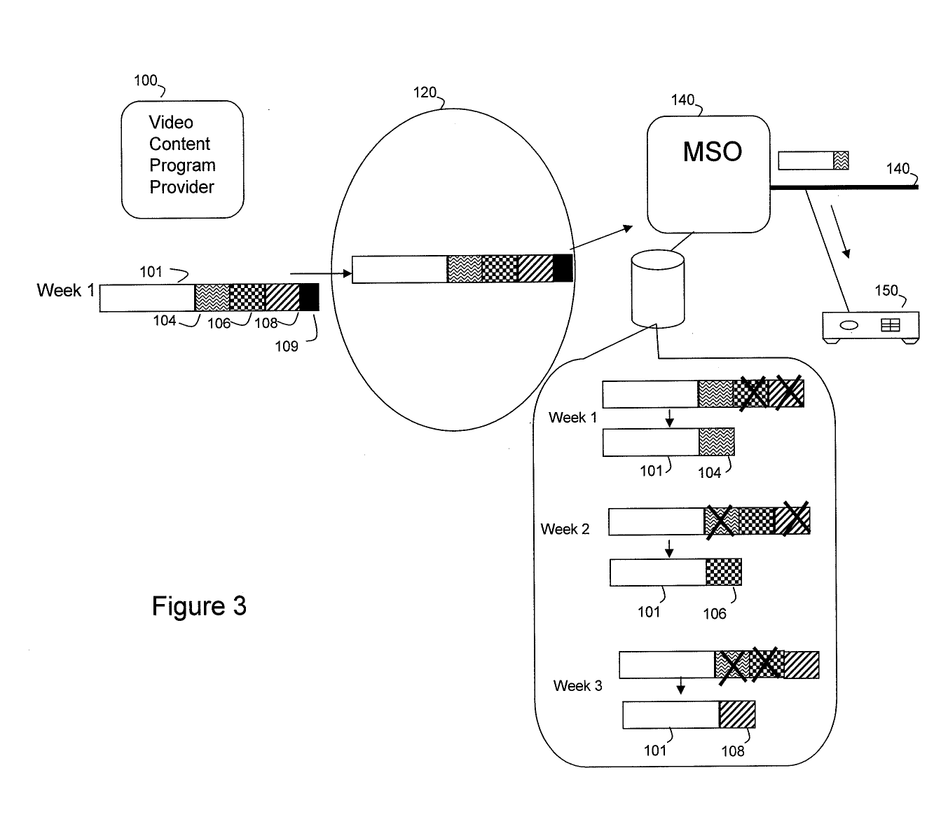

FIG. 3 illustrates another embodiment, wherein the video content provider provides a single file in a single transmission to the distributor 120, which in turn is provided to the MSO. The single file includes the program 101, along with any ads 104, 106, and 108 placed in a contiguous manner, along with the meta-data portion 109 of the file.

Upon receipt of the program, ads, and meta-data in a single file, the MSO will store the file in a database and process the file at the time required. The meta-data contains the rules and instructions for selecting the appropriate ad, and again, during week one, the file containing the program is provided over the cable network, but the meta-data indicates that the first ad 104 is to be played, and the other two skipped. Similarly, during the second week, the same program 101 is played, but the first and third ads are skipped, so that the second ad 106 is played. Finally, in week three, the first two ads are skipped and the third is used.

In another variation of the embodiment shown in FIG. 3, the program content and the ads could be sent as a single file, and the meta-data could be sent as a separate file. Other variations are possible as well. Typically, the file(s) comprising the video program and the ads are sent as a single transmission to the MSO.

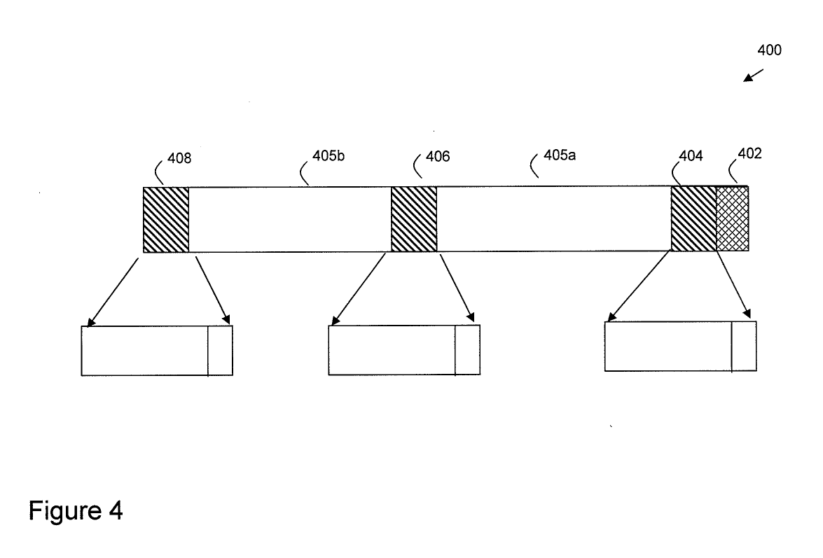

The ads are not limited to only those ads shown at the beginning of the program. As shown in FIG. 4, the file 400 may comprise a meta-data portion 402, a series of pre-roll ads 404, followed by a portion of the program 405a, followed by a series of interstitial ads 406, followed by the remainder of the program 405b, and a series of post-roll ads 408. There may be more than one set of interstitial ads 406 present in a program file. Other embodiments may combine the series of different categories of ads all in a single contiguous section with the program file. There is no requirement that the post-roll ads come after the program, or the pre-roll ads are placed before the program, but this is often the case.

The ads are not limited to advertisements, but can include promotions, previews, public service announcements, or any other form of non-program content that is combined with content based on some criteria.

The program typically contains markers, called avails, which delineates certain points at which ads can be inserted. These avails typically exist at the beginning and end of the program, and in the middle of the program. Typically, the avails in the middle of the program indicate points in the program where the context readily supports the insertion of an advertisement (for interstitial ads). These opportunities to insert ads are used to determine where to insert local ads, and the meta-data allows insertion of the national ads. Ad insertion is not required, but typically optional. Alternatively, or in addition, the markers can be indicated in the meta-data. This allows determination of where the avails are located without having to search the program serially until each avail is located. Whereever an avail is indicated, this is an opportunity for the system to select an ad from the ad library for insertion (e.g., presentation to the viewer) when streaming the video program.

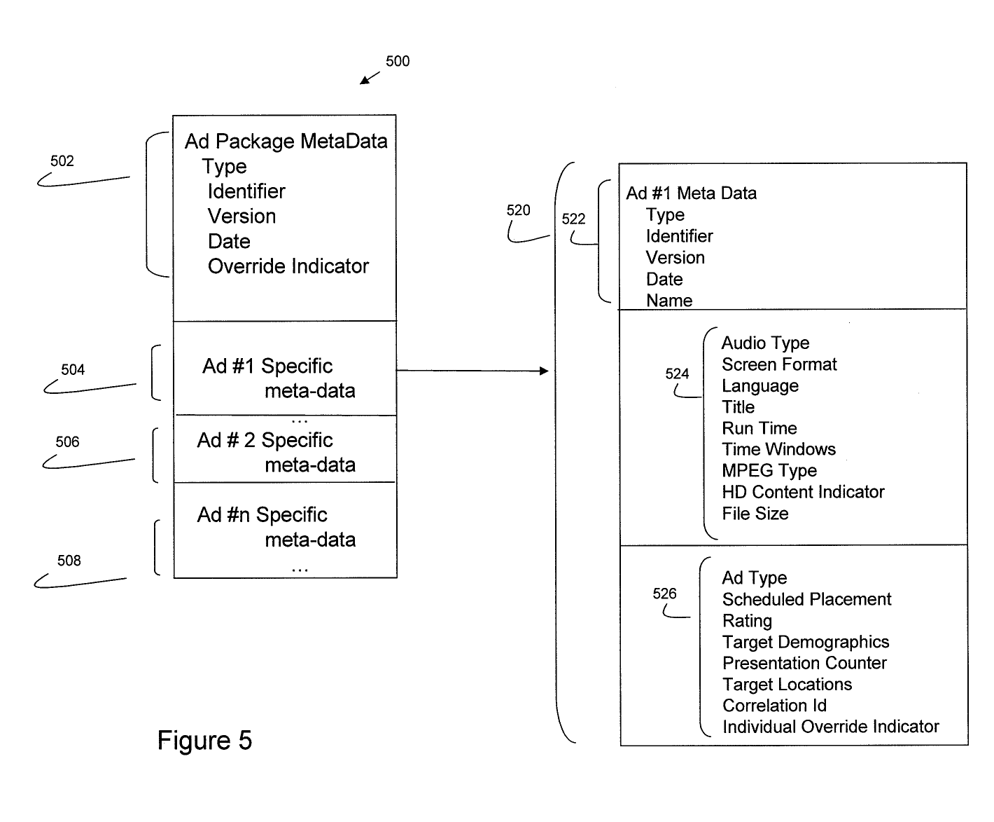

The meta-data contains the information about the ads, including generic information about the ad package (ad package meta-data) and information about the individual ads themselves (ad specific meta-data) and how they are to be selected for presentation. An exemplar form of the meta-data is shown in data structure 500 in FIG. 5, which comprises a first portion 502 of meta-data which is generic to the ads involved and is directed to the ad package overall. This comprises information that applies to each and every ad, or information which is not specific to any one individual ad.

The information contained in the ad package meta-data 502 includes an identifier as to the “type” of meta-data, in order to distinguish this ad package meta-data from the ad-specific meta-data. The “identifier” is an alphanumerical value which uniquely identifies the meta-data itself, as opposed to others. Thus, it is possible to have an ad package meta data for a plurality of pre-roll ads and another for post-roll ads, as well as a single ad package meta-data for both pre-roll and post-roll ads. A “version” indicates which of several versions the meta-data is, as the meta-data can be edited by various service providers or content producers. Thus, it is possible to alter various parameters of the same meta-data over time. A “date” similarly is used to indicate a time-stamp of the meta-data. The “override indicator” provides information to the processors of the individual ad meta-data regarding the extent to which the information contained can be ignored, or overridden. As it will be seen, the ads indicated may be all required to be played at their scheduled times, without exception. Other service providers may chose, if allowed by the override indicator, to replace or substitute an ad with another.

The meta-data 500 contains ad-specific portions 504-508 each of which are associated with a particular ad among the plurality of ads conveyed with the program. A typical structure of the ad-specific meta-data 520 is shown on the right portion of FIG. 5.

In this case, the ad-specific meta-data 520 also has similar identifying information 522. In this case, the “type” is set to “ad specific” in order to distinguish this ad-specific meta-data from ad package meta-data. The meta-data is identified by a “identifier” which facilitates computer identification, and a “version” and “date” information, which function to identify one of several versions which may exist, and the date which functions as a time-stamp and indicates when contents was last changed (if at all). A “name” field is used to facilitate human identification of the meta-data. In summary, the ad-specific identification portion 522 comprises various information allowing it to be distinguished and identified for various purposes.

The remainder of the ad-specific meta-data can be divided into two portions for illustration purposes. However, embodiments may alter the order of the information, or even add or subtract the various types indicated. The first portion 524 can be categorized as information about the ad itself that is required for downstream receiving equipment to properly process the ad after it has been selected. The following information are illustrative of such meta-data:
Audio Type—This indicates whether the program is recorded in a particular audio format, including such as sampling rate, stereo format (e.g., Dolby Surround Sound™), etc.
Screen Format—This indicates a particular resolution and aspect ratio associated with the ad.
Language—This indicates what language the audio track is recorded in. Other information can indicate what language the secondary audio channel is provided in.
Title—this indicates a name of the ad, which is largely to facilitate human identification of the ad.
Run Time—this indicates the length of the ad, typically in seconds (e.g., 30 second ad, 60 second ad, etc.).
Time Windows—this indicates the time period during which the ad should be played. This could be relative (e.g., play ad with first showing of program) or absolute (e.g., play between January 15-25). Other indications may indicate that the ad could be played anytime. Other schemes indicating when the particular ad can be shown are possible (such as earliest or latest possible showing dates, or that the ad should be shown in the evening or morning times, etc.).
MPEG Type—this indicates the MPEG version and/or other related information regarding the video encoding used to convey the ad.
HD Content Indicator—this indicates whether the ad is in high definition format or not.
File Size—this indicates the size of the ad file itself.

Other fields may be included, which those skilled in the art would readily identify as potentially being useful in order to properly process the ad after it has been selected for viewing.

The second portion of parameters 526 includes information used to select the particular ad for playing with the program. These selection parameters can be loosely though of as information that potentially can be used to evaluate whether the ad is selected. Not all information present is necessarily required to be used to select the program.

To an extent, the information about the ad itself in the above parameters 524, can be used in selecting an ad. Thus, there is not always a clear distinction of information which is used to process the ad for viewing and the information used to select the ad. For example, a 60 second ad is not eligible to be selected for a 30 second spot, nor can an ad be selected outside of its time windows. Thus, the boundaries between the parameters about the ad itself 524 and the parameters about how to select the ad 526 are not always clearly distinguishable. The parameters 526 used in ad selection can be thought as being typically less dependent on the technical aspects of the ad.

The ad selection parameters 526 comprise:
Ad Type—this indicates whether the ad is national, regional, or local in its intended viewing area. The content of ads can be aimed at a national audience and suitable for playing in any region. For example, an ad promoting a national airline potentially can be targeted for any part of the country. However, other ads are regional in nature and are intended to appeal to viewers in a certain state or part of the country. For example, ads featuring snow ski resorts may be suitable for selection in portions of the western portions of the U.S., but probably not in the southeast. Finally, local ads, which often feature local merchants, are only suitable for a specific town, metropolis, metropolitan serving area(s) (MSA) and/or rural serving area(s) (RSA).
Scheduled Placement—this indicates a preferred time, order, or other information indicating when the ad should be shown. This can indicate which ads are to be used in a particular time order (e.g., ad #1 to be used in first week), or placement within the program (ad #1 is to be used for pre-roll, interstitial, or post-roll). Specifically, this can include indicators which reflect pre-roll, post-roll, or interstitial selection of the ad. Other combinations are possible.
Rating—a value, which can be standardized along the familiar “G, PG, R” rating values that indicates some object characteristic of the ad. In other embodiments a proprietary assignment scheme can be used, such a characteristic of the intended ad audience, including age levels, school grade level, male/female audience members, etc.
Target Demographics—this indicates a characteristic of the target audience, such as average income, political affiliation, family size, etc. Any type of encoding scheme or characteristic can be used, and multiple characteristics can be indicated as well. This parameter allows an ad to be targeted in an effective manner to its intended audience. For example, an ad for children's' health services would be more likely targeted to a serving area having families, as opposed to single adults.
Presentation Counter—this records the number of time the ad has been shown, and can be used to maintain track of how many times the program has been viewed. This could also encompass a countdown counter, indicating how many times are left that the program should be presented. Selection of the ad maybe based on the counter's value. It is possible to define sub-counters which track presentation of the program with respect to other criteria, such as how many times the program has been shown to a particular target demographic audience. Thus, the presentation counter could be used to ensure that the ad is shown, for example, at least two times to each of a subset of demographic groups.
Target Locations—this indicates particular areas for which the ad is to be shown. Options include defining metropolitan statistical areas (MSAs), cities, cable systems, zip codes, or any other identifier associated with a particular service area.
Correlation Identifier—this provides a value pointing to a rules database, indicating how this ad should be selected. A cable services provider could define a set of rules for impacting how and when an ad is selected. Such rules could be standardized or unique to a cable service provider. The particular rules or rules in the database can be referenced by the correlation identifier. Thus, selection of an ad could be linked to a rule providing processing instructions to the ad selection equipment, which could not be easily conveyed in the meta-data. For example, reference to a rule can be made indicating that a first ad can be replaced with another ad if the first ad's rating is “R” and the ad is tentatively scheduled to be shown before 8:00 p.m.
Individual Override Indicator—this indicates to what degree the scheduled placement of the ad must be adhered to. Potential values are: never override or override allowed.

Other criteria can be defined, such as overriding with certain conditions.

It is possible that other parameters may be defined, or that some of the parameters above may not be present. It is possible for both standardized parameter values can be used, or proprietary values. It is also possible for various entities to edit or modify the meta-data along the distribution channels to tailor the ads as appropriate. In addition, in some embodiments the above parameters may be set by the program provider, and communicated along with the ad. In other embodiments, the information may be set or determined by the ad selector processor after the ad is received. For example, the presentation counter is typically a value that is set by the ad selector processor after the ad has been selected, and which can be used when subsequently determining whether to select the ad fro a subsequent avail. Further, the correlation identifier could have a standardized format, as well as a local proprietary format. Similarly, the Individual Override Indicator could have a value indicated from the content provider, as well as a value indicated by a local MSO.

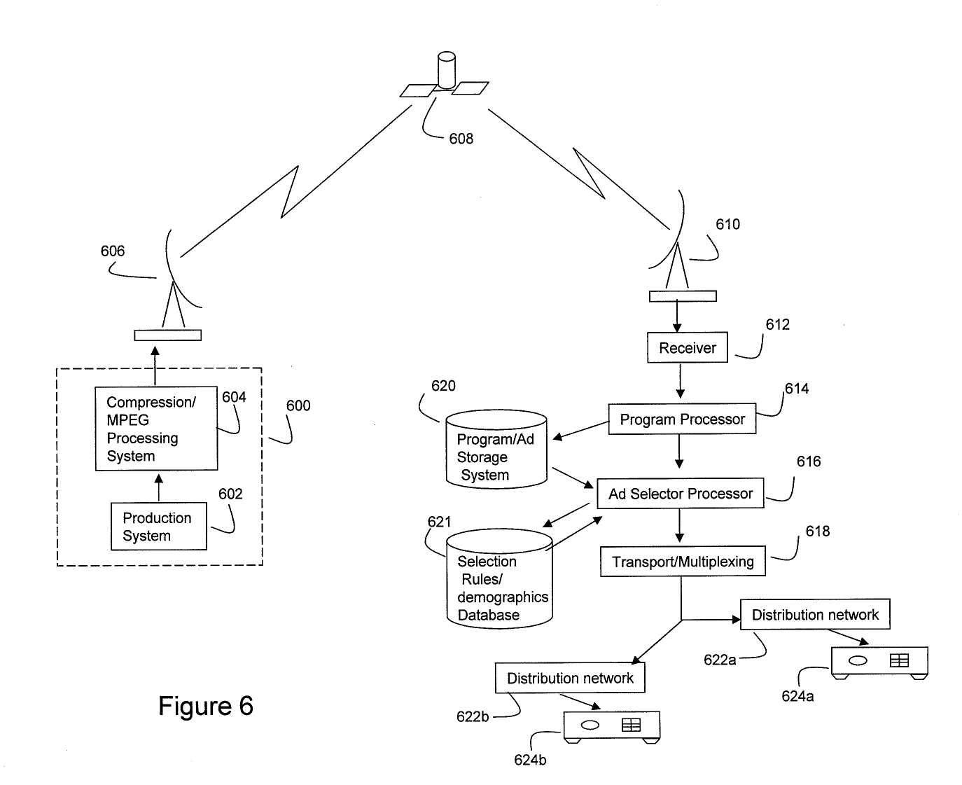

The environment in which the above system operates is shown in FIG. 6. In FIG. 6, a program producer/distributor 600 produces the files for transmission by receiving the program (not shown) and combining it in a production system 602 with a plurality of ads, as previously discussed in regards to FIG. 2 and FIG. 3. Specifically, the plurality of ads may be combined into one file with the program, or together as a separate file. The resulting file(s) are sent for compression and/or conversion to MPEG by a system 604. The files are then transmitted by a satellite transmitter 606 to a satellite 608, which are then relayed to the appropriate earth station represented by receiver dish 610 and receiver 612. The files are received by a program processor 614 which typically stores the program/ad files in a database 620 for future processing. Typically, the ad are selected fro the program when the program is being streamed out to the cable network.

When the appropriate time occurs for streaming out the program, the contents of the program and associate ads are retrieved by the ad selector processor 616 which contains the logic for selecting which of the ads is to be selected. In a simple case, the ad selection could be based on the ad specific meta-data indicated in the ad files that merely indicates the scheduled order in which the ads are to be placed.

However, it is possible that the cable services provider operates multiple systems, shown in FIG. 6 as distribution network 622a and 622b. Selection of the appropriate ad may not only involve which ad is to be selected at which time (e.g., an ad is to be selected for the first week's showing of the program or the second week's showing of the program), but and/or selection of the ad for a particular distribution network. The ad selector processor has access to a selection rules/demographics database 621, which not only defines the rules by which programs are selected using the meta-data, but also indicates various characteristics (e.g., demographics) of the respective distribution networks 622 and regarding the individual viewers, embodied by the individual set top boxes 624a-624b. Thus, the ad selector processor uses the meta-data and the selection rules to select the appropriate ads. The resulting program and ad is sent to the transport/multiplexing equipment 618 in the head end, and it is transmitted to the appropriate distribution networks 622 and to the set top boxes 624.

The process by which the ad selector determines which ad to use when streaming a program is varied, and hence it is not feasible to indicate each possible combination. Hence, a single example is provided to illustrate the application of the principles of the present invention.

Assume that the ads and program are stored in the storage system 620, and correspond to the program and ads discussed in context of FIG. 3, namely there is a program with three potential pre-roll ads, which one of which has to be selected. Further, assume that the program is being shown for a second week by the cable system operator. The Ad Selector 616 retrieves the program, and must select an ad from one of the three ads. Presumably, one of the ads was previously shown with the program

First, assume that the selected ad pertains to a luxury automobile, and the ad is produced for a regional chain of auto dealerships selling that brand of car. Thus, the selection meta-data for the ad might be:
a. Ad Type: regional
b. Scheduled Placement: any time
c. Rating: G (general audience)
d. Target Demographics: Household income greater than $75,000.
e. Presentation Counter: 0 (not shown before)
f. Target Locations: Cities defined by MSA as Atlanta, Gainesville, and Macon (all of Georgia).
g. Correlation ID: See rule #9
h. Individual Override Indicator: allowed
   In this example, the Ad Type is regional ad, which reflects that the ad advertises a luxury car offered by a regionally owned car dealership. Thus, the ad would not be effective for showing in parts of the country. However, if the ad pertained to brand of the car, without focusing on a particular dealership, then it would be applicable. The ad's Schedule Placement parameter indicates it can run at any time—it is not time sensitive (e.g., it is not a holiday promotion) so that it can be selected for any of the possible selections during the indicated time window. The Rating indicates it is suitable for general audiences. A key selection criteria may be indicated in the Target Demographics parameter, namely that the ad should be shown in areas having a greater than $75 k household income. The Presentation Counter indicates the ad has not been shown before. Otherwise, another ad may be selected for presentation. The Target Locations indicates potential locations corresponding to locations served by the cable services provider, which can be cities or merely a region. The Correlation ID indicates that Rule #9 should be followed, and this rule in the selection rules database 621 of FIG. 6 may be defined such that this ad should not be shown after midnight and before 6:00 a.m. The Individual Override Indicator allows other ads to be substituted.

It is not practical to discuss all the combinations as to how the meta-data may be processed. However, if the ad were a national ad, then the program producer may require it to be shown in the scheduled order, without any overrides. Alternatively, the Target Demographics parameter may indicate a household income of any value if the automobile being advertised was a basic economy model, as opposed to a luxury model.

In this manner, the ad selector processor can retrieve the program, analyze the meta-data to select the appropriate ad, and stream the ad followed by the program over the distribution network. When an avail is indicated for an interstitial ad, or the post-roll ad, the ad selector processor further examines the meta-data to select the next appropriate ad in advance of the avail, retrieves the selected ad from storage system, and interrupts the streaming of the video program to streams the ad at the appropriate point. After the ad has been streamed, the video program streaming is resumed. As used herein, “streaming” and “transmitting” are synonymous and mean providing the information to the transport/multiplexing equipment for transmission over the cable distribution network.

Thus, the interaction of the processing rules, the meta-data, and other selection rules results in flexibility in allowing selection of an ad for a program that is repeated for several time periods. In this case, the selection of the ad for the luxury car is intended to be presented to those portions of the certain MSAs where the household income is of a certain level. This allows both the program producer and the cable system provider the ability to transmit a single program with a plurality of ads, while ensuring that both the program producer and the cable system provider have the flexibility in ensuring an ad is effectively selected.

In a simple ad selection process, the receiving cable system selects the ads as instructed in the meta-data. In a more complex selection process, the cable system maintains data against which the demographic and other criteria is compared against, which allows flexibility in selecting the ad. Thus, the present invention provides for an efficient means of providing a program from a content provider along with a plurality of ads, and associated meta-data to a cable service provider, and provides flexibility as to how the ads are selected for multiple presentations of the program.

That which is claimed:

1. A method of selecting an ad from among a plurality of ads for streaming along with a video program on a cable distribution system, comprising the steps of:
receiving a single instance of said video program comprising a plurality of avails, a plurality of ads, and meta-data all in a digital format comprising a single transmission from a program content provider at a receiver at said cable system wherein said meta-data comprises a plurality of ad-specific meta data wherein each ad-specific meta-data is associated with a respective one of the plurality of ads;
storing said single instance of said video program, said plurality of ads, and said meta-data in a file storage system;
retrieving said single instance of said video program and said meta-data from said file storage system at a later time;
selecting one of the plurality of ads as a pre-roll ad by an ad selection processing system based on said meta-data;
retrieving said one of the plurality of ads as said pre-roll ad from said file storage system by said ad selection processing system; and
streaming said ad on said cable distribution system followed by streaming said at least a portion of said single instance of said video program on said cable distribution system.

2. The method of claim 1 further comprising the step of:
said ad selection processing system modifying a counter in one of the plurality of ad-specific meta-data associated with said one of the plurality of ads, said counter indicating selection of said one of the plurality of ads.

3. The method of claim 1 wherein said meta-data comprises ad specific schedule placement data indicating when each respective one of said plurality of ads should be selected for a respective plurality of avails of said single instance of said video program.

4. The method of claim 3 wherein said meta-data comprises ad schedule placement data indicating for each respective plurality of ads a pre-roll, interstitial, or post-roll selection location for each one of the plurality of ads.

5. The method of claim 1 wherein said ad-specific meta-data comprises an ad type parameter for each respective one of the plurality of ads indicating said respective one of the plurality of ads is at least one from the group of a national ad type and a local ad type.

6. The method of claim 1 further comprising the steps of:
interrupting streaming of at least said portion of said single instance of said video program on said cable distribution system;
selecting another one of the plurality of ads by said ad selection processing system as an interstitial ad based on said meta-data;
streaming said another one of the plurality of ads by said ad selection processing system on said cable distribution system followed by streaming a remaining portion of said single instance of said video program on said cable distribution system.

7. The method of claim 6 wherein the selection of said one of the plurality of ads and the selection of another one of the plurality of ads by said ad selection processing system is based on demographics data contained in said respective ad-specific meta-data for the one of the plurality of ads and the another one of the plurality of ads.

8. The method of claim 7 wherein the ad selection processing system accesses a database for retrieving data for comparison with said demographics data for completing selection of said one of the plurality of ads and the selection of the another one of the plurality of ads.

9. The method of claim 1 wherein the step of receiving said single instance of said video program, a plurality of ads, and meta-data all in a digital format in a single transmission at a receiver comprises receiving a satellite transmission at said receiver at said cable system.

10. The method of claim 9 wherein the step of receiving said single instance of said video program, a plurality of ads, and meta-data all in a digital format in a single transmission at a receiver at said cable system comprises receiving a single file comprising said video program, said plurality of ads, and said meta-data.

11. A system for selecting one of a plurality of ads for inclusion in presenting a video program, said system comprising:
a receiver for receiving a single instance of said video program comprising a plurality of avails, said plurality of ads, and meta-data in a digital format at said cable system wherein said meta-data comprises a plurality of ad-specific meta-data wherein each ad-specific meta-data is associated with a respective one of the plurality of ads;
a file storage system storing said single instance of said video program, said plurality of ads, and said meta data;
an ad selector processor configured to retrieve said single instance of said video program from said file storage system for streaming said single instance of said video program, said ad selector processor configured to select one of the plurality of ads as a pre-roll ad based on said meta-data and to retrieve said one of the plurality of ads from said file storage system, said ad selector processor configured to cause said one of the plurality of ads and at least a portion of said single instance of said video program to be streamed; and
a cable distribution system configured to receive and stream said one of the plurality of ads followed by said portion of said single instance of said video program to a plurality of cable subscribers.

12. The system of claim 11 wherein the ad selector processor is configured to update a counter associated with said selected one of the plurality of ads and store said counter in said respective ad-specific meta-data in said file storage system.

13. The system of claim 11 wherein the meta-data comprises ad schedule placement data indicating how each respective plurality of ads should be selected for said respective plurality of avails associated with said single instance of said video program.

14. The system of claim 13 wherein the meta-data comprises ad schedule placement data indicating for each respective plurality of ads a pre-roll, interstitial, or post-roll selection location for each one of the plurality of ads.

15. The system of claim 11 wherein the meta-data comprises ad-specific meta-data for each respective one of the plurality of ads indicating said respective one of the plurality of ads is of a national or local ad type.

16. The system of claim of claim 11 wherein the ad selector processor is configured to interrupt said streaming of said single instance of said video program on said cable distribution system and select another one of the plurality of ads as an interstitial ad based on said meta-data.

17. The system of claim 16 wherein the ad selector processor is configured to select said one of the plurality of ads and the another one of the plurality of ads based on demographics data contained in said respective ad-specific meta-data for the said one of the plurality of ads and the another one of the plurality of ads.

18. The system of claim 17 wherein the ad selector processor is configured to retrieve data from a demographics database for use in selecting said one of the plurality of ads and the another one of the plurality of ads.

19. The system of claim 11 wherein said receiver receives said single instance of said video program, said plurality of ads, and meta-data in a digital format in a single file.

20. The system of claim 11 wherein the ad selector processor is configured to retrieve said single instance of said video program from said file storage system for streaming after a time period, said ad selector processor configured to select one of the remaining plurality of ads as a pre-roll ad based on said meta-data and retrieving said one of the remaining plurality of ads from said file storage system, said ad selector processor configured to stream said one of the remaining plurality of ads and a remaining portion of said single instance of said video program.

21. A method of selecting an ad from among a plurality of ads for streaming along with a video program on a cable distribution system, comprising the steps of:
receiving a single instance of said video program comprising a plurality of avails, a plurality of ads, and meta-data all in a digital format comprising a single satellite transmission from a program content provider at a receiver at said cable system wherein said meta-data comprises a plurality of ad-specific meta data wherein each ad-specific meta-data is associated with a respective one of the plurality of ads;
storing said single instance of said single instance of said video program, said plurality of ads, and said meta-data in a file storage system;
retrieving said single instance of said video program and said meta-data from said file storage system at a later time;
selecting one of the plurality of ads for streaming for one of the plurality of avails by an ad selection processing system based on said meta-data;
retrieving said one of the plurality of ads as said pre-roll ad from said file storage system by said ad selection processing system; and
streaming said ad on said cable distribution system followed by streaming said at least a portion of said single instance of said video program on said cable distribution system.

22. The method of claim 21 wherein the ad comprises one from the group of public service announcements, movie promotions, and previews.
